(19) United States
(12) Patent Application Publication
(10) Pub. No.: US 2017/0208187 A1
(43) Pub. Date: Jul. 20, 2017

(54) PHOTO AND TEMPLATE CRAFT AND RELATED SYSTEMS AND METHODS

(71) Applicant: Devon A. Rolf, Overland Park, KS (US)

(72) Inventor: Devon A. Rolf, Overland Park, KS (US)

(21) Appl. No.: 15/411,020

(22) Filed: Jan. 20, 2017

Related U.S. Application Data
(60) Provisional application No. 62/281,102, filed on Jan. 20, 2016.

(51) Int. Cl. H04N 1/00; G06F 3/12

(52) U.S. Cl. CPC H04N 1/00167; H04N 1/00145; H04N 1/00188; G06F 3/1243; G06F 3/1272; H04N 1/00177; G06Q 30/0633

(57) ABSTRACT

Improvements to a craft kit that enable receiving a photograph and generating a template of the photograph include components for printing the template on adhesive-backed canvas for mounting to a panel or frame, entering a product code to enable generation of the template, generating the template in color and enabling the colored template to be printed or submitted for production of a piece of artwork. Further improvements include enabling the user to select one or more themes for use in generating the template wherein the template is then generated with at least one shape associated with theme, enabling the user to select one or more particular shapes for incorporation into the template, and generating the template with one or more images associated with an organization, such as a logo, a character, or a caricature.

### PRIORITY CLAIM

This application claims priority to U.S. Provisional Patent Application No. 62/281,102 entitled IMPROVEMENTS TO PHOTO AND TEMPLATE CRAFT AND RELATED SYSTEMS AND METHODS, Filed Jan. 20, 2016, which is incorporated herein by reference in its entirety.

### BACKGROUND

Field

Embodiments of the present invention relate to photo and template crafts. More particularly, embodiments of the present invention relate to a photo and template craft kit and method for creating a template array presenting a representation of an image, wherein the array is then completed with paint or colored markers or pencils.

Related Art

The present inventions, as described here, are improvements on the systems, methods, processes and products specified in U.S. patent application Ser. No. 13/358,378, filed Jan. 25, 2012, entitled Photo and Bead Craft and Related System and Method, which is incorporated herein in its entirety by reference.

### SUMMARY

In particular, the present invention comprises a craft kit and a system and method of generating a template for a craft kit and a system and method for completing a craft. Improvements to the inventions described in the aforementioned U.S. patent application Ser. No. 13/358,378, which describes software and a craft kit that enables a digital photo to be converted into a template that is completed by placing colored beads or colored marker on corresponding areas of the template to create a pixelized photorealistic craft, include the following noted improvements.

It is an object and embodiment of the invention to include in a craft-kit at least one adhesive-backed, light- or medium-weight canvas sheet (and preferably a plurality of such canvas sheets) for placement in a printer (such as an inkjet printer) for printing a template generated in accordance with the present invention. The canvas sheets are preferably lightweight canvas with a relatively smooth surface and are 8.5×11 inches in size so that they fit in a standard ink-jet or laser printer. The canvas sheets have a peel-off back layer that exposes an adhesive backing to enable the canvas sheet, with printed template thereon, to be adhered to a surface, such as a wood panel. A canvas sheet from the craft kit is placed in a user's home printer so that the template is printed on the canvas side.

Such canvas sheets are known. However, such canvas sheets are usually manufactured with a clear, ink-jet receptive coating that makes printing on the canvas sharper than is the case if the coating is not present. The present invention is, in one embodiment, a printable canvas sheet that does not have such a coating. Testing has revealed that printing a template on a coated canvas sheet and then completing the template with colored markers that are paint based, such as higher end artist markers, causes the ink used to print the template to smear, whereas such smearing is eliminated or greatly minimized when using paint based markers and printing on a canvas sheet that does not have ink-jet receptive coating. Additionally, the added sharpness and clarity that a person may desire if printing a photograph on a canvas sheet is not necessary for a template of the present invention, since it is the user who will complete the artwork on the canvas with paint or paint markers.

In another embodiment, the canvas sheet does have its conventional coating. In such an embodiment, it is an object and an improvement of the invention to specifically use ink based markers, which testing has shown do not produce (or greatly reduce) running of the ink in the template with the marker ink is applied to the template.

The improvement of an adhesive-backed canvas sheet that can be printed on a home ink-jet printer has a number of advantages. One advantage is that the canvas sheet enables a higher-quality finished product than using conventional paper and is better resistant to curling when coated with ink during the artist/crafter's coloring process or tearing when being colored by the artist/crafter. Additionally, such a sheet enables production of a canvas finished piece of artwork that can be placed on a panel to have the appearance of a stretched piece of canvas on a frame, but that does not require printing the canvas and framing it at a commercial printer/framing operation. Additionally, the use of an adhesive backed piece of canvas enables the finished artwork to be easily and removably adhered to a desired surface, such as a panel as described herein.

A second improvement includes positioning the template with a significant and equal or substantially equal margin at the top and bottom of the page and, in one embodiment, centering the template for printing on the page so that it prints centered on the canvas sheet. Sheets typically roll through an inkjet printer when printing. Testing has revealed that printing the template near the top margin of the canvas sheet can cause a few of the rows in the array of the template to be scrunched, whereas positioning the template more centrally on the sheet solves this problem. In an embodiment of the invention, the template is printed at least two inches from the top and bottom margin.

A third improvement includes a wood panel that has a square face upon which the template is adhered. In one embodiment, the template is cut-out, adhered to the panel, and then completed with colored markers (preferably 8 colored paint markers, other numbers of markers may be used). This approach enables the edges of the craft to be colored even if the template was cut too short (because the face of the panel can be painted in those areas) and to trim any excess part of the template that overhangs the edge of the panel. In another embodiment, the template is first completed with the colored markers, and then cut and placed on the panel. The panel preferably has painted black edges or has edges that are painted by the user as part of the craft, and can be placed on a surface or hung on a wall. It should be understood that the panel may be a single piece of wood, or a panel formed of a peripheral, rear frame of wood (such as canvas stretcher pieces) and a front face, thereby resulting in a panel with a depth that depends on the thickness of the frame pieces (such as for example, resulting in a ¾ inch depth, 1 inch depth, 1½ inch depth or other depths). The wood panel may be thick enough to stand on its own or it may include a hole on the rear side for receiving a small peg which aids in propping the panel up on a surface. The wood panel may include a slot or a hole to receive a wall hanger or nail for hanging or may include a hanger for hanging on a nail. The front face may be made of wood, MDF or other materials and may be covered with gesso or ground materials, such as plastic, to create a “canvas effect”. In one embodiment, the size of the face of the panel matches the size of the template to be cut out. In another embodiment, the face of the panel is larger than the template so that a border of the face, which is painted or can be painted by the user, is visible at the edge of the template. In another embodiment, the face of the panel is smaller than the template and the canvas sheet wraps around the edge of the panel. In one embodiment, the face of the panel is 6 inches by 6 inches.

In accordance with the invention, “pixel” sizes for the template are exactly ⅛^{th} by ⅛^{th} inch or within 1/32^{nd} or 1/64^{th} of an inch of ⅛^{th} by ⅛^{th} inch. This size is ideal for use of a chisel-tipped paint marker having a ⅛^{th} inch tip. Thus, a 6×6 inch panel can have a template of 48 (rows)×48 (columns) or a template with slightly less pixels (such as 44×44, 45×45, 46×46 or 47×47) to leave some room for margin created by array lines in the template. Accordingly, it is an object of the invention to use 1⅛^{th} inch tipped, colored chisel-tipped paint markers.

In embodiments of the invention, a template is generated and the areas (i.e., small squares or other shapes as specified herein) are colored to create a completed template that is viewed on a display screen. In one embodiment, the user may then print the colored template on a colored printer, cut way the margins as necessary, and place it in a frame or adhere it on a panel as described herein. The user does not need to finish the template as a craft with markers. In another embodiment, the user selects an input to submit the template for production of a finished piece of artwork. In such an embodiment, the received submission is printed at a production facility, the artwork is completed, and the artwork is shipped to the user at an address that has been entered by the user during creation of the template. More particularly, as an example, the submitted template is professionally printed on quality art paper and mounted to a board or backing or framed or is printed on canvas and wrap mounted to a frame in known art work production manners. In still another embodiment, the colored template is hand finished by an artist (such as by water coloring, pencil coloring, or painting on canvas) who completes the various areas with colored art supplies. The finished artwork is then mounted or framed as appropriate for the artwork medium being used and is shipped to the customer.

It is known in the art to generate different shapes in a template for coloring. In other words, it is known to generate shapes of different flowers or flora instead of square pixels. This creates a more interesting visual effect. An improvement of the present invention is to generate shapes that correspond with known characters, caricatures, and/or logos. This improvement enables the present invention to be sold or licensed as a product to organizations who want to enable employees or customers or members to create a artwork with an uploaded photo that includes colored areas or areas for coloring that correspond to an item associated with the organization. As one example, customers to a Disney® theme could purchase a craft kit or a completed printed colored artwork based on a template of his or her photograph, where the template is a printed colored template or a template to be colored, in which the different areas in the template are defined by Disney characters. In other words, Mickey Mouse® may be shaded brown (or to be colored a first color) and Minnie Mouse® may be shaded a charcoal color (or to colored a second color). In a variation, different portions of a character may be shaded a different color (e.g., the body the legs of Mickey Mouse® are tan or to be colored a first color, the body is brown or to be colored a second color, and the head is black or to be colored a third color). Numerous variations are possible.

In still other embodiments, the shaped areas (whether for completion by the user, printed by the user, printed by a production facility, or hand-finished by production artists) are selected by the user. In one embodiment, the user has the ability to select a theme (such as by visually viewing theme categories and associated shapes) and the template is generated with shapes corresponding to the theme. Examples include, but are not limited to (i) sports (images may in include running shoes, cleats, balls of various types that are used in sports, rackets, helmets, jerseys, goals, pads, sporting suits for a variety of sports such as football, basketball, baseball, volleyball, soft ball, soccer, swimming, track and field, tennis, racquetball, golf, bicycling, skate-boarding, water skiing, snow-skiing, etc.) (ii) dance with various shapes relating to dance such as musical notes, dance shoes or slippers, leotards, ribbons, etc., (iii) music with various shapes relating to music such as musical notes and instruments of various types, etc. (iv) animals. In other embodiments, users can individually select various items up to a selected number of items from different categories. In such a way, the user can select items that are of interest to the user. Additionally, an embodiment of the invention enables only one or a handful of such items to be selected with the rest of the spaces to fill-out the template constituting traditional shapes (such as squares). So a template of a girl who loves to play the violin and dance ballet may include only a violin, ballet slippers, and squares (or other standard shapes) with the violin appearing in the template corresponding to a particular color and the dance slippers appearing in the template corresponding to a second color but with the rest of the colors (perhaps 5-15 more colors depending on the template generation embodiment being used in the present invention) are standard shapes.

In accordance with another aspect of the improved invention, in addition to printing the template on a canvas sheet, a method of the invention includes also printing the cropped photo which was used to create the template on a second canvas sheet and adhering the printed photo to the rear of the panel (in that regard, the panel may have a rear face or the photo may be adhered at his rear periphery to the frame components of the panel such that it spans the depth of the panel). In this way, the craft may be placed on a credenza so viewing it from one size shows the completed craft and viewing it from the other side shows the photo. Alternatively, the craft may be displayed in traditional fashion, but may be turned around to show the picture that was used for the craft.

In one embodiment, a floater-frame upon which to place the panel is included in a craft kit.

In accordance with an additional aspect of the invention, product codes are generated and a product code is printed on a label or insert for each kit. For example, a retailer may order 1,000 craft kits for sale in its retail stores. To complete the order, 1,000 unique product codes are generated and one of those codes is printed for insertion in each kit. The code identifies the retailer. The system of the present invention may enable the product code to be used once or multiple times. A purchaser of the craft kit is directed to a website at which the user is prompted to enter the code. Entry of the code gives the user access to the photo uploading, cropping, previewing, and template-creating online tools of the present invention. By requiring such a code, non-purchasers of a craft kit are deterred from simply using the template creating online tool at no cost to them and then purchasing their own materials to complete the craft, which would result in loss of income to the provider of this craft. Codes could be reused with some corresponding reduction in security.

In one embodiment, a sixteen digit code is used. As described, the codes are generated in a way to identify a particular customer or entity, much like a credit card number identifies a card network and a bank issuer. Such an approach enables software on a server used in the web-based system of the present invention to track (i.e., store in a database) which codes have been entered and thereafter perform statistical analysis.

For example, a batch of codes may be sold (or sold with kits) to a first merchant who desires to place craft kits in its retail stores. The batch of codes includes a common merchant identifier. More granularity can be provided such that a retailer with multiple location or regions may wish for different sub codes within the code to identify particular geographical regions or stores. Codes and/or kits with codes sold through different channels (e.g., physical retail stores, online only, group sales, may include different identifying subcodes). Codes may be generated to include a date and/or codes may be stored with a data field in a database for date tracking and statistical analysis.

In accordance with another aspect of the invention, for a bulk order, a single product code may used for the entire order, such that each person in a group will have the same product code. Alternatively, each product in a bulk order may have its own product code.

In accordance with another aspect of the invention, product codes may time-out and/or be set to work only in a desired calendar range. For example, a camp that made a bulk order may be issued a single code (or multiple codes) and provided the materials for each of the campers to complete the craft, with the product code(s) being useable only during a particular calendar range known to coincide with the camp.

In accordance with another aspect of the invention, once a code is entered at the website for generating a template, graphics, logos, slogans, announcements, coupons, etc. may be presented on the website that correspond to the merchant or organization that has purchased or distributed the products corresponding to that code. In particular, such graphics of a particular entity (such as a merchant or distributor or bulk purchaser of the craft kit) may be stored in a database and retrieved and presented on webpages of the website, using known web-development techniques, when a code corresponding to the entity is entered into the website. Additionally, the website may include a link to another website or webpages associated with the entity. In this way, the unique product code entered provides the basis for generating and displaying unique hyperlinks for affiliate tracking for additional orders placed on the linked other website or webpages.

In accordance with another aspect of the invention, processing steps are provided by the software that enable a user to download a generated template so that the user can have the template on his or her own computer after the user's online session for creating the template is ended. This would enable the user to re-print the template (such as on an extra canvas sheet provided in the craft kit) if the user made a mistake on the craft and wanted to start over or, for example, spilled juice or coffee on their craft. Additionally, the present invention enables the user to input on the website when generating and printing the template whether the template printed properly, with one flow process being illustrated in FIG. 1 and further flow and website portions being illustrated in FIG. 2.

In one embodiment of the invention, a greeting card kit is provided. The greeting card kit may include a greeting card, an adhesive backed sheet for placement in a printer for printing the template (such as an adhesive backed canvas sheet), colored markers, and instructions. In one embodiment, the instructions provide an indication of which markers to obtain and use and the markers are not included in the kit. The user uploads a photo to the website and generates a template. The template is printed on the adhesive backed sheet. The craft is completed by filling in the spaces on the template with corresponding colored markers and the backing on the adhesive backed sheet is removed and the sheet is adhered to the front of the greeting card.

### BRIEF DESCRIPTION OF THE DRAWINGS

FIG. 1 is a flowchart illustrating methods of the present invention.

FIG. 1 is a flowchart 10 of a method of the present invention. At step 11, a user purchases or is provided an artwork product according to the invention. This product may be as simple as packaging and/or instructions for completing the product or may also include a frame or panel and one or more adhesive backed pieces of canvas. The product includes a uniquely generated code as described herein.

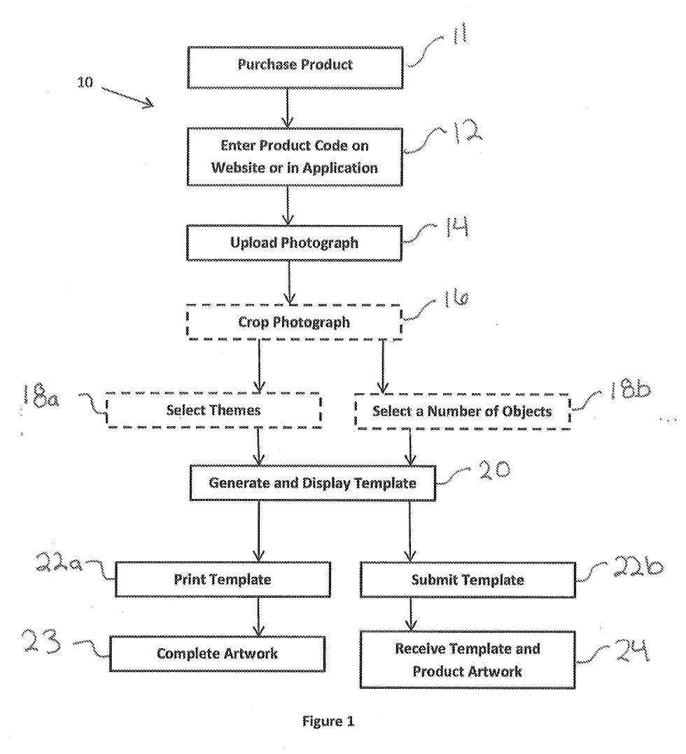

At step 12, the user uses an online software application and/or website user interface that interfaces with template generation software of the invention to enter the code. It should be understood that entering the code enables completion of the artwork product and can be entered at any step of the process. As an example, the system prompts the user to enter the code in a field and, upon entry of the code, the user is able to upload the photo at step 14.

At step 14, the user uploads a photo, such as a photo of the user or a friend or family member.

At step 16, the user may crop the photo (or skip this step if cropping is not desired).

At optional step 18a, the user selects a theme from a list of provided themes for generating the template so that at least some of its areas are defined by items corresponding to the selected theme or at optional step 18b the user selects a number of individual objects for use as some of the areas of the template to be generated.

At step 20, the template is generated and displayed to the user on a display screen of a user's device. In embodiments in which the generated template includes one or more themes or individual objects selected by the user, such objects are incorporated into the template. In embodiments (as described herein) in which the template is to correspond to a particular organization (such as Disney®), one or more of the template areas are displayed as images (such as characters, known images or logos) corresponding to the organization.

At step 22a (according to embodiments), the user selects to print the template. As described, in one embodiment the template is printed to be completed by the end user (at step 23) with markers or paints according to instructions (which may be in the kit or printed with the template; the markers/paints may or may not be included in the kit). In another embodiment, the colored template is printed on a colored printer for display by the end user (such as in step 23 adhering it to the panel, placing in a frame, etc.). At step 22b (according to embodiments), the user selects to submit the template. At step 24, the submitted template is received and used to produce a professional quality piece of artwork (as described herein, such as printing on canvas and professionally mounting, printed on quality art paper and mounted or framed, etc., hand finished by an artist who paints or colors the shaped areas and the finished art is mounted or framed, etc.) and in this embodiment the produced artwork is shipped to the user.

It should be understood that embodiments and features herein may be combined. It should be understood that the foregoing is not limiting but illustrative. It should be understood that entry of the code to enable completion of the artwork may be completed at any step of the process including at the beginning, at the end just before printing or submitting the template, or at any step in between including partial template generation and display and then entering the code to complete its generation.

I claim:

1. A method comprising:
entering a product code to enable completion of a template that is generated from a photograph.

2. The method of claim 1 wherein said entering of a product code to enable completion of a template that is generated from a photograph comprises enabling at least one of (i) a photograph to be input, (ii) a photograph to be cropped, (iii) a template based on an input photograph to be completed, (iv) a template based on an input photograph to be colored or for coloration of the template to be completed, (v) a template based on an input photograph to be printed, and (vi) a template based on an input photograph to be submitted for production of artwork based on said submitted template.

3. The method of claim 1 further comprising generating a template including at least one shape that is indicative of a shape associated with an organization.

4. The method of claim 3 wherein said generating a template including at least one shape that is indicative of a shape associated with an organization comprises generating a template that includes a shape indicative of at least one of a logo, a caricature, and a character.

5. The method of claim 1 further comprising generating a template including at least one shape that is indicative of a shape associated with a selected theme.

6. The method of claim 1 further comprising generating a template including at least one shape that is selected by the user.

7. The method of claim 1 further comprising generating said template and enabling printing of said template.

8. The method of claim 1 further comprising generating said template and enabling a download of said template.

9. The method of claim 1 further comprising generating said template and enabling submission of said template for use in producing a piece of artwork.

10. The method of claim 9, said method further comprising receiving a submitted template, printing said submitted template, and mounting or framing the printed template.

11. The method of claim 9, said method further comprising receiving a submitted template, printing said submitted template, and sending said printed template to an address.

12. The method of claim 9, said method further comprising receiving said completed template and hand-finishing said completed template by placing color on the template.
